(19) United States
(12) Patent Application Publication
(10) Pub. No.: US 2024/0168268 A1
(43) Pub. Date: May 23, 2024

(54) ATHERMALIZED LENS SYSTEMS AND METHODS

(71) Applicant: Teledyne FLIR Commercial Systems, Inc., Goleta, CA (US)

(72) Inventor: David Ovrutsky, Charlotte, NC (US)

(21) Appl. No.: 18/502,893

(22) Filed: Nov. 6, 2023

Related U.S. Application Data
(60) Provisional application No. 63/426,309, filed on Nov. 17, 2022.

(51) Int. Cl. G02B 13/14

(52) U.S. Cl. CPC G02B 13/14

(57) ABSTRACT

Techniques for facilitating athermalized lens systems and methods are provided. In one example, an imaging device includes a lens system. The lens system includes a first lens element configured to transmit electromagnetic radiation associated with a scene. The lens system further includes a second lens element configured to receive the electromagnetic radiation from the first lens element and transmit the electromagnetic radiation. The lens system further includes a third lens element configured to receive the electromagnetic radiation from the second lens element and transmit the electromagnetic radiation. The first and third lens element include As₄₀Se₆₀ and the second lens element includes Ge₂₂As₂₀Se₅₈ or Ge₂₈Sb₁₂Se₆₀. The imaging device further includes a detector array including a plurality of detectors. Each detector is configured to receive a portion of the electromagnetic radiation from the lens system and generate an infrared image based on the electromagnetic radiation. Related methods and systems are also provided.

### CROSS-REFERENCE TO RELATED APPLICATIONS

This application claims priority to and the benefit of U.S. Provisional Patent Application No. 63/426,309 filed Nov. 17, 2022 and entitled “ ATHERMALIZED LENS SYSTEMS AND METHODS,” which is incorporated herein by reference in its entirety.

### TECHNICAL FIELD

One or more embodiments relate generally to optical components and more particularly. for example, to athermalized lens systems and methods.

### BACKGROUND

Imaging systems may include an array of detectors arranged in rows and columns, with each detector functioning as a pixel to produce a portion of a two-dimensional image. For example, an individual detector of the array of detectors captures an associated pixel value. There are a wide variety of image detectors, such as visible-light image detectors, infrared image detectors, or other types of image detectors that may be provided in an image detector array for capturing an image. As an example, a plurality of sensors may be provided in an image detector array to detect electromagnetic (EM) radiation at desired wavelengths. In some cases, such as for infrared imaging, readout of image data captured by the detectors may be performed in a time-multiplexed manner by a readout integrated circuit (ROIC). The image data that is read out may be communicated to other circuitry, such as for processing, storage, and/or display. In some cases, a combination of a detector array and an ROIC may be referred to as a focal plane array (FPA). Advances in process technology for FPAs and image processing have led to increased capabilities and sophistication of resulting imaging systems.

### SUMMARY

In one or more embodiments, an imaging device includes a lens system. The lens system includes a first lens element configured to transmit electromagnetic radiation associated with a scene. The lens system further includes a second lens element configured to receive the electromagnetic radiation from the first lens element and transmit the electromagnetic radiation. The lens system further includes a third lens element configured to receive the electromagnetic radiation from the second lens element and transmit the electromagnetic radiation. The first lens clement and the third lens element include As₄₀Se₆₀ and the second lens element includes Ge₂₂As₂₀Se₅₈ or Ge₂₈Sb₁₂Se₆₀. The imaging device further includes a detector array including a plurality of detectors. Each of the plurality of detectors is configured to receive a portion of the electromagnetic radiation from the lens system and generate an infrared image based on the electromagnetic radiation.

In one or more embodiments, a lens system includes a first lens element configured to transmit electromagnetic radiation associated with a scene. The lens system further includes a second lens element configured to receive the electromagnetic radiation from the first lens element and transmit the electromagnetic radiation. The lens system further includes a third lens element configured to receive the electromagnetic radiation from the second lens element and transmit the electromagnetic radiation. The first lens element and the third lens element include As₄₀Se₆₀ and the second lens element includes Ge₂₂As₂₀Se₅₈ or Ge₂₈Sb₁₂Se₆₀.

In one or more embodiments, a method includes directing, by a lens system including a first lens element, a second lens element, and a third lens element, electromagnetic radiation associated with a scene to a detector array. The first lens element and the third lens element include As₄₀Se₆₀ and the second lens element includes Ge₂₂As₂₀Se₅₈ or Ge₂₈Sb₁₂Se₆₀. The method further includes receiving, by the detector array, the electromagnetic radiation. The method further includes generating, by the detector array, an infrared image based on the electromagnetic radiation.

The scope of the present disclosure is defined by the claims, which are incorporated into this section by reference. A more complete understanding of embodiments of the present disclosure will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates a block diagram of an imaging device in accordance with one or more embodiments of the present disclosure.

FIG. 2 illustrates a perspective view of an imaging device in accordance with one or more embodiments of the present disclosure.

FIG. 3 illustrates a cross-sectional view of an optical system in accordance with one or more embodiments of the present disclosure.

FIG. 4 illustrates a flow diagram of an example process for manufacturing an imaging device in accordance with one or more embodiments of the disclosure.

FIG. 5 illustrates a flow diagram of an example process for using an imaging device in accordance with one or more embodiments of the present disclosure.

FIG. 6 illustrates a block diagram of an example imaging system in accordance with one or more embodiments of the present disclosure.

FIG. 7 illustrates a block diagram of an example image sensor assembly in accordance with one or more embodiments of the present disclosure.

Embodiments of the present disclosure and their advantages are best understood by referring to the detailed description that follows. It is noted that sizes of various components and distances between these components are not drawn to scale in the figures. It should be appreciated that like reference numerals are used to identify like elements illustrated in one or more of the figures.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more embodiments. In one or more instances, structures and components are shown in block diagram form in order to avoid obscuring the concepts of the subject technology. One or more embodiments of the subject disclosure are illustrated by and/or described in connection with one or more figures and are set forth in the claims.

In one or more embodiments, athermalized lens systems and methods are provided. In some aspects, such systems and methods may be used for infrared imaging, such as thermal infrared imaging. In one embodiment, an imaging device includes a detector array, optical elements to direct electromagnetic radiation associated with a scene to the detector array, and a lens barrel within which to dispose and hold/secure the optical elements. The imaging device may include a housing coupled to the lens barrel. The housing may include (e.g., enclose) the detector array. In some cases, the housing may include a logic device to process image data from the detector array, memory to store raw image data and/or processed image data, a battery, and/or other components to facilitate operation of the imaging device. By way of non-limiting examples, an optical element may include a lens element, a window, a mirror, a beamsplitter, a beam coupler, and/or other component.

The detector array may receive electromagnetic radiation directed (e.g., projected, transmitted) by the lens elements onto the detector array. In this regard, the electromagnetic radiation may be considered image data. The detector array may generate an image based on the electromagnetic radiation. The lens elements and/or other optical element(s) of the imaging device may be transmissive of electromagnetic radiation within a waveband dependent on a desired application. In an aspect, the imaging device may be an infrared imaging device for facilitating capture of a waveband encompassing at least a portion of the thermal infrared spectrum, such as a long-wave infrared (LWIR) spectrum. In infrared imaging applications, the detector array may include an array of microbolometers and/or an array of other types of infrared detectors.

In an embodiments, the imaging device includes a lens system including at least three lens elements. In some cases, the imaging device may also include other optical elements upstream of the lens elements, downstream of the lens elements, and/or interspersed between two lens elements. As non-limiting examples, a lens element may include silicon, germanium, chalcogenide glass (e.g., As₄₀Se₆₀, germanium arsenide selenium (GeAsSe), Ge₂₂As₂₀Se_{58,} Ge₃₃As₁₂Se₅, Ge₂₈Sb₁₂Se₆₀), zinc selenide, organic material such as polyethylene and 4-methylpentene-1-based olefin copolymer (TPX), and/or generally any lens material appropriate for infrared applications. Lens material used to manufacture the lens element(s), respectively, are generally based on a desired application. For example, lens material may be selected to allow a desired transmission waveband of the lens elements. In some aspects, each lens element is formed of chalcogenide material. In some cases, chalcogenide lenses may be used due to their cost effectiveness and moldability. Lens elements may be formed using wafer-level optics (WLO) manufacturing processes, such as polymer formation on a substrate followed by a transfer etch, grinding processes, polishing processes, diamond turning processes, and/or molding processes. In some embodiments, the lens elements may preferably be made using diamond turning processes and/or molding processes.

The lens system may include a first/front lens element (e.g., closest to a scene), a second/middle lens element, and a third/back lens element (e.g., closest to the detector array relative to other lens elements). In an embodiment, in the three-lens system, the first/front lens element and the third/back lens element may contain (e.g., be made/formed of) the same material and the second/middle lens element may contain (e.g., be made/formed of) a different material from the first/front lens element and the third/back lens element. In an embodiment, the first/front lens clement and the third/back lens element may contain the same chalcogenide material and the second/middle lens element may contain a different chalcogenide material. The first/front lens element and the third/back lens element may be made of chalcogenide material As₄₀Se₆₀ and the second/middle lens element may be made of chalcogenide material Ge₂₂As₂₀Se₅₈ or Ge₂₈Sb₁₂Se₆₀.

In some embodiments, a lens system may have more or fewer than three lens elements dependent on application (e.g., desired focal length), as would be understood by one skilled in the art.

In some embodiments, a lens system (e.g., a multi-element lens system/assembly) may be athermalized over a temperature range. As an example, the athermalization may be achieved across a temperature range from around −40° C. to around +80° C. By athermalizing the lens system, the lens system may maintain focus even when a temperature of one or more lens elements of the lens system changes. Proper athermalization of infrared optics, such as LWIR optics, is important to achieve high performance. In some aspects, a combined focal length of a lens system (e.g., including contributions from a focal length of each lens element of the lens system) may provide a figure of merit indicative of whether a lens system is or is not properly athermalized. For example, a combined effective focal lens of a lens system stable within a desired temperature range may indicate proper athermalization. Athermalization may generally be desired in lens elements having longer effective focal length (EFL). As an example, microbolometer FPAs are generally large and are accommodated using lens elements having appropriately large apertures (e.g., f1.0 lenses) to achieve a desired signal-to-noise ratio (SNR) performance.

In a non-athermalized lens/optical system, a change in a temperature of the lens system may cause the lens system to lose focus due to a change in an index of refraction of an optical component(s) (e.g., a lens element(s)) in response to a temperature change of the optical component(s), a change in a size (e.g., an expansion, a contraction) of the optical component(s) in response to the temperature change of the optical component(s), and/or a change in a size of a spacer(s) (e.g., aluminum spacer(s)) between optical components in response to a temperature change of the spacer(s). In this regard, each optical component may contain (e.g., be formed of) material having a temperature-dependent index of refraction and a temperature-dependent size. In some cases, for a given material (e.g., lens element material, spacer material), a relationship between a change in the size of the component and a change in the temperature of the material may be provided by a coefficient of thermal expansion (CTE) of the material.

In some aspects, a lens system may be athermalized through optical athermalization. To effectuate optical athermalization, the material and the focal lengths of lens elements of the lens system may be selected during a lens design process, with the individual lens elements designed to distribute a total optical power of the multi-element lens assembly among at least two lens elements in such a way that relative changes in focal lengths of individual lens elements work towards a cancellation of the change in the combined focal length of the lens assembly as a result of a change in temperature. In some aspects, to facilitate optical athermalization, the lens system includes three lens elements. A front lens element and a back lens element may be formed of the same material (e.g., same chalcogenide material) and a middle lens element between the front and back lens elements may be formed of a different material (e.g., different chalcogenide material) from the front and back lens elements. As non-limiting examples, the front and back lens elements may be made of chalcogenide material As₄₀Se₆₀ and the middle lens element may be made of chalcogenide material Ge₂₂As₂₀Se₅₈ or Ge₂₈Sb₁₂Se₆₀. In some cases, in response to a temperature change, the front and back lens element may be made of a material that exhibits a smaller change in its index of refraction than a material of the middle lens element.

The lens elements provide degrees of freedom to allow a change in optical power in one or more lens elements due to a change in an index of refraction and/or an expansion or a contraction to be cancelled out by a change in optical power in one or more of the remaining lens elements. As an example, in response to an expansion of the three lens elements due to a temperature change, the front lens element may exhibit a higher positive optical power (relative to without the temperature change) and the middle and back lens elements may exhibit a higher negative optical power such that the change in optical power of the three lens elements substantially cancel out. As a similar example, since optical power and focal length are related, in response to a temperature change, a focal length of at least two of the three lens elements may change such that a combined focal length of the overall three-lens system is substantially unchanged. In cases with spacing material, the lens system may also cancel out effects associated with any changes in the spacing material (e.g., changes in index of refraction and/or size) due to the temperature change.

In some aspects, in addition to optical thermalization, the lens system may be athermalized using active focus adjustment and/or passive mechanical athermalization. In active focus adjustment, one or more lenses and/or the detector array may be translated along an optical axis to compensate a defocus (e.g., thermal defocus) occurring due to a change in an index of refraction and an expansion of lens materials as well as an expansion of a lens housing (e.g., aluminum or magnesium lens housing). To effectuate the active focus adjustment, the lens system may include or may be coupled to a sensor(s) (e.g., thermistor(s)) that measures a temperature of the lenses and a motor(s) that translates one or more of the lenses and/or the detector array based on the temperature measurements. In passive mechanical athermalization, a defocus may be compensated by an expansion of a compensator assembled inside a lens housing made of a material having a certain CTE which is significantly different (e.g., significantly higher or significantly lower) than the CTE of the lens housing material. The compensator may be, or may be referred to as, an insert (e.g., a cylindrical insert) or a spacer. The compensator may be assembled in such a way that as a result of a thermal expansion or contraction at least one lens element is passively moved (e.g., translated along an optical axis) in a direction which offsets the defocus.

Although various embodiments are described primarily with respect to infrared imaging, methods and systems disclosed herein may be utilized in conjunction with devices and systems such as imaging systems having visible-light and infrared imaging capability, mid-wave infrared (MWIR) imaging systems, short-wave infrared (SWIR) imaging systems, light detection and ranging (LIDAR) imaging systems, radar detection and ranging (RADAR) imaging systems, millimeter wavelength (MMW) imaging systems, ultrasonic imaging systems, X-ray imaging systems, microscope systems, mobile digital cameras, video surveillance systems, video processing systems, or other systems or devices that may need to obtain image data in one or multiple portions of the electromagnetic spectrum.

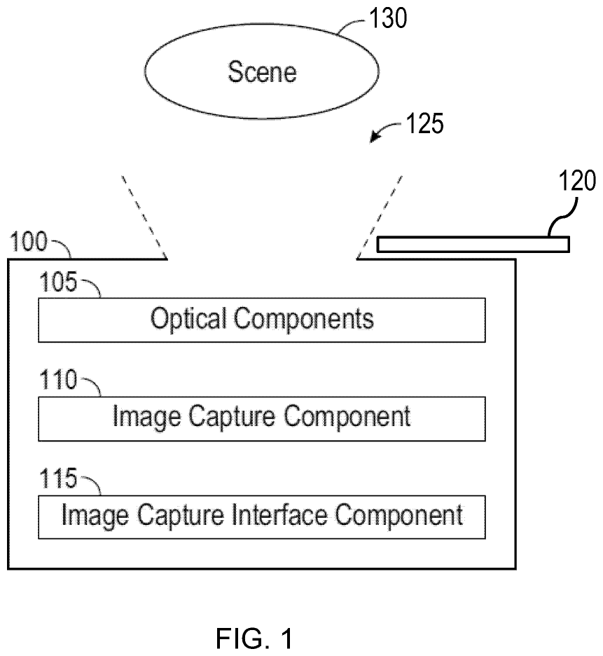

Referring now to the drawings, FIG. 1 illustrates a block diagram of an imaging device 100 in accordance with one or more embodiments of the present disclosure. In an embodiment, the imaging device 100 may be an infrared imaging device. The imaging device 100 may be used to capture and process image frames. The imaging device 100 includes optical components 105, an image capture component 110, an image capture interface component 115, and an optional shutter component 120.

The optical components 105 may receive electromagnetic radiation through an aperture 125 of the imaging device 100 and pass the electromagnetic radiation to the image capture component 110. For example, the optical components 105 may direct and/or focus electromagnetic radiation on the image capture component 110. The optical components 105 may include one or more windows, lenses, mirrors, beamsplitters, beam couplers, and/or other components. In an embodiment, the optical components 105 may include one or more chalcogenide lenses, such as lenses made of As₄₀Se₆₀, Ge₂₂As₂₀Se₅₈, and/or Ge₂₈Sb₁₂Se₆₀. that allow for imaging in a wide infrared spectrum. Other materials, such as silicon and germanium, may be utilized. The optical components 105 may include components each formed of material and appropriately arranged according to desired transmission characteristics, such as desired transmission wavelengths and/or ray transfer matrix characteristics. In an embodiment, the optical components 105 are athermalized across a temperature range of −40° C. to +80° C.

The image capture component 110 includes, in one embodiment, one or more sensors (e.g., visible-light sensor, infrared sensor, or other type of detector) for capturing image signals representative of an image of a scene 130. The image capture component 110 may capture (e.g., detect, sense) infrared radiation with wavelengths in the range from around 700 nm to around 1 mm, or portion thereof. For example, in some aspects, the image capture component 110 may include one or more sensors sensitive to (e.g., better detect) thermal infrared wavelengths, including LWIR radiation (e.g., electromagnetic radiation with wavelength of 7-14 μm). The sensor(s) of the image capture component 110 may represent (e.g., convert) or facilitate representation of a captured thermal image signal of the scene 130 as digital data (e.g., via an analog-to-digital converter).

The image capture interface component 115 may receive image data captured at the image capture component 110 and may communicate the captured image data to other components or devices, such as via wired and/or wireless communication. In various embodiments, the imaging device 100 may capture image frames, for example, of the scene 130.

In some embodiments, the optical components 105, image capture component 110, and image capture interface component 115 may be housed in a protective enclosure. In one case, the protective enclosure may include a lens barrel (e.g., also referred to as a lens housing) that houses the optical components 105 and a housing that houses the image capture component 110 and/or the image capture interface component 115. In this case, the lens barrel may be coupled to the housing. In an aspect, the protective enclosure may be represented by the solid-line box in FIG. 1 having the aperture 125. For example, the aperture 125 may be an opening defined in the protective enclosure that allows electromagnetic radiation to reach the optical components 105. In some cases, the aperture 125 may be an aperture stop of the imaging device 100.

Each optical element (e.g., lens element) may include at least one mating feature (e.g., also referred to as a mounting feature). The lens barrel may have a corresponding mating feature(s) that couples to a mating feature(s) of the optical element(s) to receive and secure the optical element(s). In this regard, each mating feature of an optical element may couple to a corresponding mating feature of the lens barrel to couple the optical element to the lens barrel. In one example, a mating feature of an optical element may include a first surface and a second surface at an angle (e.g., 90° angle, obtuse angle, or acute angle) relative to the first surface, and a mating feature of a lens barrel may have corresponding surfaces to couple to the first and second surfaces. In another example, a mating feature of an optical element may include a pin portion, and a mating feature of a lens barrel may include a slot portion to receive the pin portion, and/or vice versa. More generally, a mating feature(s) of an optical element and a corresponding mating feature(s) of a lens barrel may be any structure (e.g., indentation, hole, pin, or other structure) that facilitates coupling of the optical element to the lens barrel. The lens barrel may allow optical components disposed therein to maintain axial position and/or air gap between them.

In some cases, a mating feature of a lens element may be appropriate to facilitate rotation and/or other movement of the lens element. In some cases, a mating feature may be utilized to facilitate alignment of a lens element, such as via pattern recognition during molding, machining, and/or assembling. For example, one or more mating features on a surface of a lens element can be located (e.g., using pattern recognition to scan the surface) to facilitate machining of a different surface of the lens element according to a desired design. As another example, a mating feature(s) of a surface(s) of a first lens element and/or a mating feature(s) of a surface(s) of a second lens clement may be utilized to facilitate alignment of the first lens element relative to the second lens element.

The shutter component 120 may be operated to selectively inserted into an optical path between the scene 130 and the optical components 105 to expose or block the aperture 125. In some cases, the shutter component 120 may be moved (e.g., slid, rotated, etc.) manually (e.g., by a user of the imaging device 100) and/or via an actuator (e.g., controllable by a logic device in response to user input or autonomously, such as an autonomous decision by the logic device to perform a calibration of the imaging device 100). When the shutter component 120 is outside of the optical path to expose the aperture 125, the electromagnetic radiation from the scene 130 may be received by the image capture component 110 (e.g., via one or more optical components and/or one or more filters). As such, the image capture component 110 captures images of the scene 130. The shutter component 120 may be referred to as being in an open position or simply as being open. When the shutter component 120 is inserted into the optical path to block the aperture 125, the electromagnetic radiation from the scene 130 is blocked from the image capture component 110. As such, the image capture component 110 captures images of the shutter component 120. The shutter component 120 may be referred to as being in a closed position or simply as being closed.

In some aspects, the shutter component 120 may block the aperture 125 during a calibration process, in which the shutter component 120 may be used as a uniform blackbody (e.g., a substantially uniform blackbody). In some cases, the shutter component 120 may be temperature controlled to provide a temperature controlled uniform blackbody (e.g., to present a uniform field of radiation to the image capture component 110). For example, in some cases, a surface of the shutter component 120 imaged by the image capture component 110 may be implemented by a uniform blackbody coating. In some cases, such as for an imaging device without a shutter component or with a broken shutter component or as an alternative to the shutter component 120, a case or holster of the imaging device 100, a lens cap, a cover, a wall of a room, or other suitable object/surface may be used to provide a uniform blackbody (e.g., substantially uniform blackbody) and/or a single temperature source.

Although in FIG. 1 the shutter component 120 is positioned in front of (e.g., closer to the scene 130 than) all the optical components 105, the shutter component 120 may be positioned between optical components. For example, the optical components 105 may include a first group of one or more lens elements and a second group of one or more lens elements, with the shutter component 120 selectively inserted between a last lens of the first group of lens element(s) and a first lens of the second group of lens element(s). Further, alternatively or in addition, although the shutter component 120 is positioned on or in proximity to an external surface of a housing of the imaging device 100, the shutter component 120 may be positioned within the housing of the imaging device 100. In some aspects, the imaging device 100 may include no shutter components or more than one shutter component.

The imaging device 100 may represent any type of camera system which, for example, detects electromagnetic radiation (e.g., thermal radiation) and provides representative data (e.g., one or more still image frames or video image frames). For example, the imaging device 100 may be configured to detect visible light and/or infrared radiation and provide associated image data. In some cases, the imaging device 100 may include other components, such as a heater, a temperature sensor (e.g., for measuring an absolute temperature of a component of the imaging device 100), a filter, a polarizer, and/or other component. For example, an integrated heater may be coupled to the barrel of the imaging device 100.

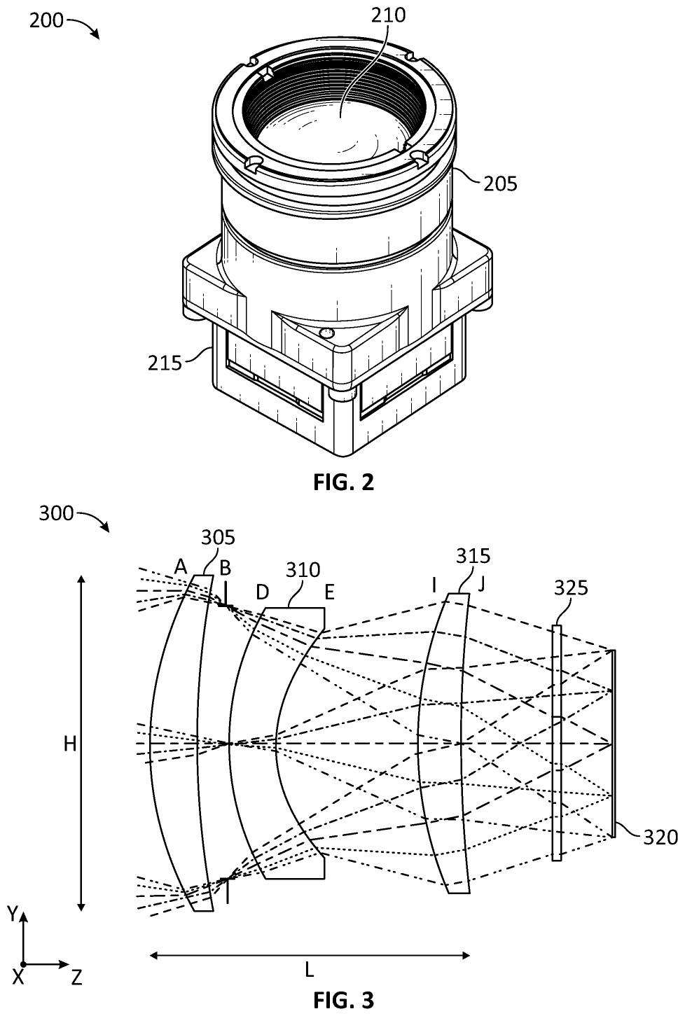

FIG. 2 illustrates a perspective view of an imaging device 200 in accordance with one or more embodiments of the present disclosure. As one example, the imaging device 200 may be an LWIR thermal camera (e.g., for capturing electromagnetic radiation with wavelengths of 7-14 μm). In other cases, the imaging device 200 may be utilized to capture electromagnetic radiation within other wavelength ranges.

The imaging device 200 may include a lens barrel 205 configured to accommodate at least a lens element 210. The lens barrel 205 may include a structure to hold/secure (e.g., fixedly secure, movably secure) the lens element 210. The imaging device 200 also may include an image capture portion 215 including an image capture component configured to capture images viewed through the lens barrel 205. The image capture portion 215 may include arrays of microbolometers configured to detect electromagnetic radiation. As one example, the arrays of microbolometers may be configured to detect long-wave infrared light of wavelengths between 7.5 μm and 13.5 μm. In an embodiment, the lens barrel 205 may be the lens barrel of the imaging device 100 of FIG. 1. In an embodiment, the imaging device 200 may be the imaging device 100 of FIG. 1. In this embodiment, the optical components 105 of FIG. 1 may include at least the lens element 210, and the image capture component 110 of FIG. 1 may include the image capture portion 215.

In some cases, the lens barrel 205 may be configured to accommodate a window in front of (e.g., closer to a scene than) the lens element 210. The window may selectively pass electromagnetic radiation of the scene. In some cases, the window may be a protective window placed in front of the lens element 210 to protect the lens element 210 and/or other components of the imaging device 200 from environmental damage, mechanical damage, and/or other damage. Physical properties (e.g., material composition, thickness and/or other dimensions, etc.) of the window may be determined based on a waveband(s) desired to be transmitted through the window. The lens barrel 205 may include structure to hold/secure (e.g., fixedly secures, movably secures) the window and/or the lens element 210.

FIG. 3 illustrates a cross-sectional view of an optical system 300 in accordance with one or more embodiments of the present disclosure. The optical system 300 is oriented along three orthogonal directions, denoted as X, Y, and Z. The X-direction and the Y-direction may be referred to as the horizontal direction and the vertical direction, respectively. In particular, FIG. 3 illustrates a cross-sectional view of the optical system 300 in the YZ-plane. The optical system 300 includes lens elements 305, 310, and 315 and a detector array 320. As an example, a lens system formed of the lens elements 305, 310, and 315 may provide a field of view (FOV) of 25° or narrower. As an example, a focal length associated with the lens system may be 20 mm or greater. In some cases, a lens system may be implemented using fewer than three lens elements for applications in which the focal length may be less than 20 mm. In an embodiment, the optical components 105 of FIG. 1 may include the lens elements 305, 310, and 315, and the image capture component 110 of FIG. 1 may include the detector array 320.

Examples of materials of the lens elements 305, 310, and/or 315 may include As₄₀Se₆₀, Ge₂₂As₂₀Se₅₈, Ge₃₃As₁₂Se₅, Ge₂₈Sb₁₂Se₆₀, germanium, zinc selenide, silicon, polyethylene, and TPX. In some cases, one or more coatings may be disposed on the lens elements 305, 310, and/or 315. By way of non-limiting examples, a coating may be an anti-reflective (AR) coating, a polarization coating, impact-resistant coating, and/or other coating. In an embodiment, the lens elements 305 and 315 are formed of the same material (e.g., same chalcogenide material) and the lens element 310 is formed of a different material (e.g., different chalcogenide material) from the lens elements 305 and 315.

The lens elements 305, 310, and 315 may coordinate to direct and focus infrared light onto the detector array 320. The lens element 305 receives the electromagnetic radiation and directs the received electromagnetic radiation to the lens element 310. The lens element 310 receives the electromagnetic radiation from the lens element 305 and directs the electromagnetic radiation received from the lens element 305 to the lens element 315. The lens element 315 receives the electromagnetic radiation from the lens element 310 and directs the electromagnetic radiation received from the lens element 310 to the detector array 320. As such, the lens elements 305, 310, and 315 collectively project the scene onto the detector array 320. In this regard, FIG. 3 illustrates at least a portion of a scene ray traced through the lens elements 305, 310, and 315 to the detector array 320. The lens element 305 has a surface A and a surface B opposite the surface A. The surface A of the lens element 305 faces the scene. The lens element 310 has a surface D and a surface E opposite the surface D. The surface D of the lens element 310 faces the surface B of the lens element 305. The lens element 315 has a surface I and a surface J opposite the surface I. The surface I of the lens element 315 faces the surface E of the lens element 310. The surface J of the lens element 315 faces the detector array 320.

As a non-limiting example, a distance between the surface B of the lens element 305 and the surface D of the lens element 310 may be between around 0.1 mm and around 200 mm. As a non-limiting example, a thickness of a thickest portion of the lens element 305 may be between around 1 mm and around 20 mm, a thickness of a thickest portion of the lens element 310 may be between around 1 mm and around 20 mm, and a thickness of a thickest portion of the lens element 315 may be between around 1 mm and around 20 mm. As a non-limiting example, a size H (e.g., extending from around a bottom surface to a top surface of the lens element 305) may be from around 0.1 mm to around 200 mm. As a non-limiting example, a size L (e.g., extending from around the surface A of the lens element 305 to the surface J of the lens element 315) may be from around 0.1 mm to around 200 mm. The dimensions of H and L generally depend on an image diagonal of the detector array 320. For a given pixel size, a larger pixel count is generally associated with a larger lens. As a non-limiting example, a distance between the surface J and the detector array 320 may be from around 0.1 mm to around 30 mm.

In some aspects, as shown in FIG. 3, a window, such as a window 325, may be disposed between the lens element 315 and the detector array 320. The window 325 may be disposed in front of the detector array 320 to selectively pass electromagnetic radiation to the detector array 320. The surface J of the lens element 315 faces the window 325. Physical properties (e.g., material composition, thickness and/or other dimensions, etc.) of the window 325 may be determined based on a waveband(s) desired to be transmitted through the window. The window 325 may be provided as a lid for the detector array 320. The window 325 may be provided to protect the detector array 320 and form a vacuum between sensors (e.g., microbolometers) of the detector array 320 and the window 325. In some cases, the window 325 may be used to provide filtering, polarization, and/or other optical effects in addition to protection. In some cases, one or more coatings (e.g., polarization coating. AR coating, impact-resistant coating) may be disposed on the window 325 to provide the filtering, polarization, protection, and/or other effects.

The detector array 320 receives the electromagnetic radiation and generates an image based on the electromagnetic radiation. In an aspect, the image may be processed using processing circuitry downstream of the detector array 320. As non-limiting examples, the detector array 320 may have a size of 160×120 sensors (e.g., 160×120 array of microbolometers), 320×256 sensors, 640×512 sensors, and 1280×1024 sensors.

In some embodiments, the optical system 300 may be athermalized over a temperature range. As an example, the athermalization may be achieved across a temperature range from around −40° ° C. to around +80° C. By athermalizing the optical system 300, the optical system 300 may maintain focus even when a temperature of one or more components of the optical system 300 changes. Proper athermalization of infrared optics, such as LWIR optics, is important to achieve high performance. Athermalization may generally be desired in lenses having longer EFL. As an example, microbolometer FPAs are generally large and are accommodated using lenses having appropriately large apertures (e.g., f1.0 lenses) to achieve a desired SNR performance.

In some aspects, the optical system 300 may be athermalized through optical

athermalization. To effectuate optical athermalization, the material and the focal lengths of the lens elements 305, 310, and 315 may be selected during a lens design process, with the individual lens elements designed to distribute a total optical power of the multi-element lens assembly among at least two lens elements in such a way that relative changes in focal lengths of individual lens elements work towards a cancellation of the change in the combined focal length of the lens assembly as a result of a change in temperature. In some cases, the lens elements 305 and 315 are formed of the same material (e.g., same chalcogenide material) and the lens element 310 is formed of a different material (e.g., different chalcogenide material) from the lens elements 305 and 315. As non-limiting examples, the lens elements 305 and 315 may be made of chalcogenide material As₄₀Se₆₀ and the lens clement 310 may be made of chalcogenide material Ge₂₂As₂₀Se₅₈ or Ge₂₈Sb₁₂Se₆₀. In some cases, in response to a temperature range, the first and third lens element may be made of a material that exhibits a smaller change in its index of refraction than a material of the second lens element. In some aspects, in addition to optical thermalization, the optical system 300 may be athermalized using active focus adjustment and/or passive mechanical athermalization.

The lens elements provide degrees of freedom to allow a change in optical power in one lens elements due to a change in an index of refraction and/or an expansion or a contraction to be cancelled out by a change in optical power in one or more of the remaining lens elements. As an example, in response to a temperature change, a focal length of at least two of the lens elements 305, 310, and 315 may change such that a combined focal length of the overall three-lens system is substantially unchanged. As a similar example, since optical power and focal length are related, in response to an expansion of the lens elements 305. 310, and 315 due to a temperature change, the lens element 310 may exhibit a higher positive optical power (relative to without the temperature change) and the lens elements 310 and 315 may exhibit a higher negative optical power such that the change in optical power of the lens elements 305. 310, and 315 substantially cancel out. In cases with spacing material, the lens system may also cancel out effects associated with any changes in the spacing material (e.g., changes in index of refraction and/or size) due to the temperature change.

In some embodiments, the lens elements 305, 310, and 315 are each associated with a lens prescription. In some aspects, each prescription may be expressed according to the following:

$$Z = \frac{c {S}^{2}}{1 + \sqrt{1 - ( K + 1 ) {c}^{2} {S}^{2}}} + {A}_{1} {S}^{4} + {A}_{2} {S}^{6} + {A}_{3} {S}^{8} + {A}_{4} {S}^{10} + … + {A}_{12} {S}^{26}$$

where S=x²+y²; c=1/r; r is the radius of curvature; A₁, A₂, A₃, A₄, . . . , A₁₂ are aspheric deformation constants; and K is the conic constant.

Table 1 illustrates example values of various parameters of the optical system 300. As one example, the prescription may characterize the various surfaces of the lens element at a certain temperature, such as at room temperature. When the temperature changes, the prescription of the lens element also changes.

TABLE 1
Example lens prescription for three lens system

| Coefficient | Surface A | Surface B | Surface E | Surface F | Surface I | Surface J |
|---|---|---|---|---|---|---|
| c | 0.0380441 | 0.0111482 | 0.0536268 | 0.0996765 | 0.0243983 | −0.0046130 |
| k | 0 | 0 | 0 | 0 | 0 | 0 |
| A₁ | 1.711E−05 | 9.929E−05 | 1.642E−04 | 1.518E−04 | 6.481E−05 | 6.808E−05 |
| A₂ | 1.046E−08 | −8.909E−07 | −3.640E−06 | −8.755E−06 | −1.588E−07 | −6.180E−08 |
| A₃ | −1.014E−09 | 3.305E−09 | 1.894E−08 | 7.311E−08 | 3.247E−09 | 3.271E−09 |
| A₄ | 1.888E−12 | −5.242E−12 | −2.224E−11 | −3.197E−10 | −2.427E−11 | −3.228E−11 |

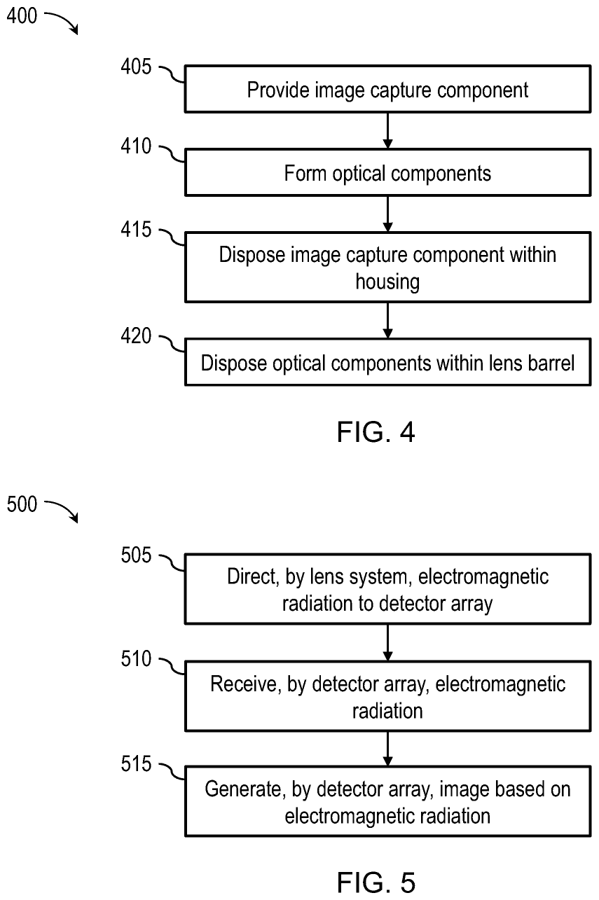

FIG. 4 illustrates a flow diagram of an example process 400 for manufacturing the imaging device 100 of FIG. 1 in accordance with one or more embodiments of the disclosure. For explanatory purposes, the example process 400 is described herein with reference to components of FIGS. 1 and 3. However, the example process 400 is not limited to the components of FIGS. 1 and 3.

At block 405, the image capture component 110 (e.g., the detector array 320) is provided. At block 410, the optical components 105 are formed. The optical components 105 may include one or more windows (e.g., the window 325) and/or one or more lens elements (e.g., the lens elements 305, 310, and 315). The lens element(s) may be formed using WLO manufacturing processes, such as polymer formation on a substrate followed by a transfer etch, grinding processes, polishing processes, diamond turning processes, and/or molding processes. For LWIR imaging applications, the window and the lens element(s) may be formed from material that is transmissive in the 7-14 μm wavebands. At block 415, the image capture component 110 is disposed within a housing (e.g., camera housing) of the imaging device 100. A window may be provided as a lid for the image capture component 110. In some cases, the window may be provided to protect a detector array and form a vacuum between sensors (e.g., microbolometers) of the detector array and the window. At block 420, the optical components 105 are at least partially disposed within a lens barrel. In some aspects, the optical components 105 may have mating features to couple to corresponding mating features of the lens barrel.

FIG. 5 illustrates a flow diagram of an example process 500 for using the imaging device 100 of FIG. 1 in accordance with one or more embodiments of the disclosure. For explanatory purposes, the example process 500 is described herein with reference to components of FIGS. 1 and 3. However, the example process 500 is not limited to the components of FIGS. 1 and 3.

At block 505, a lens system including the lens elements 305, 310, and 315 directs electromagnetic radiation associated with a scene (e.g., the scene 130) to the detector array 320. In this regard, to direct the electromagnetic radiation, the lens element 305 may receive the electromagnetic radiation from the scene and transmit the electromagnetic radiation to the lens element 310, the lens element 310 may receive the electromagnetic radiation from the lens element 305 and transmit the electromagnetic radiation to the lens element 315, and the lens element 315 may receive the electromagnetic radiation from the lens element 310 and transmit the electromagnetic radiation to the detector array 320. In some cases, the lens element 315 may transmit the electromagnetic radiation through the window 325 and to the detector array 320.

At block 510, the detector array 320 receives the electromagnetic radiation from the lens system. In this regard, each detector of the detector array 320 may receive a portion of the electromagnetic radiation from the lens system. At block 515, the detector array 320 generates an image based on the electromagnetic radiation. In some aspects, the lens system may be appropriate to transmit thermal infrared radiation and the image generated by the detector array 320 may be a thermal infrared image. In some cases, the image generated by the detector array 320 may be provided for processing, storage, and/or display. For example, the image may be provided to a processor for processing to remove distortion in the image, and the processed image may then be provided for storage, display, and/or further processing.

In some embodiments, the lens system is athermalized. When experiencing (e.g., in response to) a change in a temperature of the lens system, the lens system substantially maintains its focal length (e.g., also referred to as its combined focal length or effective focal length). The lens system may substantially maintain its focal length due to adjustments/changes in focal lengths of at least two lens elements of the lens system in response to the temperature change of the lens system. With reference to the lens system shown in FIG. 3, a change in a focal length of one or more lens elements of the lens elements 305, 310, and 315 due to the temperature change is substantially cancelled by a change in a focal length of one or more remaining lens elements of the lens elements 305, 310, and 315. For example, a change in the focal length of the lens element 305 may be at least partially cancelled by a change in the focal length of the lens element 310 and/or the lens element 315. For a given lens element, a change in the lens element's focal length may be due to a change in the lens element's index of refraction and/or size in response to the temperature change.

Although, in the optical system 300 referenced in FIG. 3 and various other figures, the optical system 300 includes a lens system having three lenses, in some embodiments, the lens system may have more or fewer than three lens elements dependent on application (e.g., desired focal length), as would be understood by one skilled in the art.

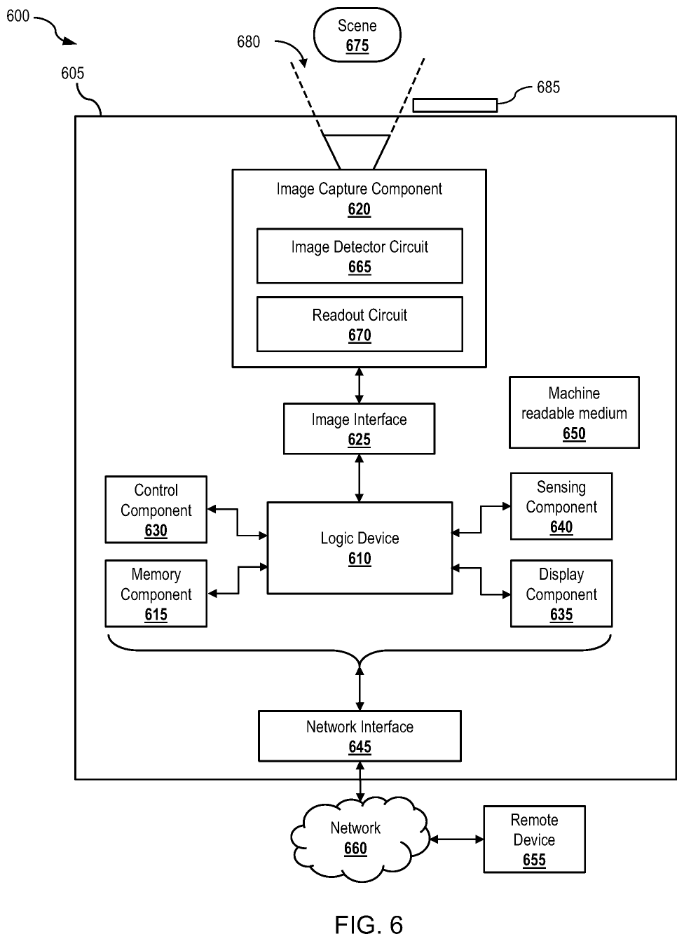

FIG. 6 illustrates a block diagram of an example imaging system 600 in accordance with one or more embodiments of the present disclosure. Not all of the depicted components may be required, however, and one or more embodiments may include additional components not shown in the figure. Variations in the arrangement and type of the components may be made without departing from the spirit or scope of the claims as set forth herein. Additional components, different components, and/or fewer components may be provided.

The imaging system 600 may be utilized for capturing and processing images in accordance with an embodiment of the disclosure. The imaging system 600 may represent any type of imaging system that detects one or more ranges (e.g., wavebands) of electromagnetic radiation and provides representative data (e.g., one or more still image frames or video image frames). The imaging system 600 may include an imaging device 605. By way of non-limiting examples, the imaging device 605 may be, may include, or may be a part of an infrared camera, a visible-light camera, a tablet computer, a laptop, a personal digital assistant (PDA), a mobile device, a desktop computer, or other electronic device. The imaging device 605 may include a housing (e.g., a camera body) that at least partially encloses components of the imaging device 605, such as to facilitate compactness and protection of the imaging device 605. For example, the solid box labeled 605 in

FIG. 6 may represent a housing of the imaging device 605. The housing may contain more, fewer, and/or different components of the imaging device 605 than those depicted within the solid box in FIG. 6. In an embodiment, the imaging system 600 may include a portable device and may be incorporated, for example, into a vehicle or a non-mobile installation requiring images to be stored and/or displayed. The vehicle may be a land-based vehicle (e.g., automobile, truck), a naval-based vehicle, an aerial vehicle (e.g., unmanned aerial vehicle (UAV)), a space vehicle, or generally any type of vehicle that may incorporate (e.g., installed within, mounted thereon, etc.) the imaging system 600. In another example, the imaging system 600 may be coupled to various types of fixed locations (e.g., a home security mount, a campsite or outdoors mount, or other location) via one or more types of mounts.

The imaging device 605 includes, according to one implementation, a logic device 610, a memory component 615, an image capture component 620 (e.g., an imager, an image sensor device), an image interface 625, a control component 630, a display component 635, a sensing component 640, and/or a network interface 645. In an embodiment, the imaging device 605 may be, may include, or may be a part of, the imaging device 100 of FIG. 1. The logic device 610, according to various embodiments, includes one or more of a processor, a microprocessor, a central processing unit (CPU), a graphics processing unit (GPU), a single-core processor, a multi-core processor, a microcontroller, a programmable logic device (PLD) (e.g., field programmable gate array (FPGA)), an application specific integrated circuit (ASIC), a digital signal processing (DSP) device, or other logic device, one or more memories for storing executable instructions (e.g., software, firmware, or other instructions), and/or or any other appropriate combination of processing device and/or memory to execute instructions to perform any of the various operations described herein. The logic device 610 may be configured, by hardwiring, executing software instructions, or a combination of both, to perform various operations discussed herein for embodiments of the disclosure. The logic device 610 may be configured to interface and communicate with the various other components (e.g., 615, 620, 625, 630, 635, 640, 645, etc.) of the imaging system 600 to perform such operations. In one aspect, the logic device 610 may be configured to perform various system control operations (e.g., to control communications and operations of various components of the imaging system 600) and other image processing operations (e.g., debayering, sharpening, color correction, offset correction, bad pixel replacement, data conversion, data transformation, data compression, video analytics, etc.).

The memory component 615 includes, in one embodiment, one or more memory devices configured to store data and information, including infrared image data and information. The memory component 615 may include one or more various types of memory devices including volatile and non-volatile memory devices, such as random access memory (RAM), dynamic RAM (DRAM), static RAM (SRAM), non-volatile random-access memory (NVRAM), read-only memory (ROM), programmable read-only memory (PROM), erasable programmable read-only memory (EPROM), electrically-erasable programmable read-only memory (EEPROM), flash memory, hard disk drive, and/or other types of memory. As discussed above, the logic device 610 may be configured to execute software instructions stored in the memory component 615 so as to perform method and process steps and/or operations. The logic device 610 and/or the image interface 625 may be configured to store in the memory component 615 images or digital image data captured by the image capture component 620.

In some embodiments, a separate machine-readable medium 650 (e.g., a memory, such as a hard drive, a compact disk, a digital video disk, or a flash memory) may store the software instructions and/or configuration data which can be executed or accessed by a computer (e.g., a logic device or processor-based system) to perform various methods and operations, such as methods and operations associated with processing image data. In one aspect, the machine-readable medium 650 may be portable and/or located separate from the imaging device 605, with the stored software instructions and/or data provided to the imaging device 605 by coupling the machine-readable medium 650 to the imaging device 605 and/or by the imaging device 605 downloading (e.g., via a wired link and/or a wireless link) from the machine-readable medium 650. It should be appreciated that various modules may be integrated in software and/or hardware as part of the logic device 610. with code (e.g., software or configuration data) for the modules stored, for example, in the memory component 615.

The imaging device 605 may be a video and/or still camera to capture and process images and/or videos of a scene 675. In this regard, the image capture component 620 of the imaging device 605 may be configured to capture images (e.g., still and/or video images) of the scene 675 in a particular spectrum or modality. The image capture component 620 includes an image detector circuit 665 (e.g., a visible-light detector circuit, a thermal infrared detector circuit) and a readout circuit 670 (e.g., an ROIC). For example, the image capture component 620 may include an IR imaging sensor (e.g., IR imaging sensor array) configured to detect IR radiation in the near, middle, and/or far IR spectrum and provide IR images (e.g., IR image data or signal) representative of the IR radiation from the scene 675. For example, the image detector circuit 665 may capture (e.g., detect, sense) IR radiation with wavelengths in the range from around 700 nm to around 2 mm, or portion thereof. For example, in some aspects, the image detector circuit 665 may be sensitive to (e.g., better detect) SWIR radiation, MWIR radiation (e.g., electromagnetic radiation with wavelength of 2 μm to 5 μm), and/or LWIR radiation (e.g., electromagnetic radiation with wavelength of 7 μm to 14 μm), or any desired IR wavelengths (e.g., generally in the 0.7 μm to 14 μm range). In other aspects, the image detector circuit 665 may capture radiation from one or more other wavebands of the electromagnetic spectrum, such as visible light, ultraviolet light, and so forth.

The image detector circuit 665 may capture image data (e.g., infrared image data) associated with the scene 675. To capture a detector output image, the image detector circuit 665 may detect image data of the scene 675 (e.g., in the form of electromagnetic radiation) received through an aperture 680 of the imaging device 605 and generate pixel values of the image based on the scene 675. An image may be referred to as a frame or an image frame. In some cases, the image detector circuit 665 may include an array of detectors (e.g., also referred to as an array of pixels) that can detect radiation of a certain waveband, convert the detected radiation into electrical signals (e.g., voltages, currents, etc.), and generate the pixel values based on the electrical signals. Each detector in the array may capture a respective portion of the image data and generate a pixel value based on the respective portion captured by the detector. The pixel value generated by the detector may be referred to as an output of the detector. By way of non-limiting examples, each detector may be a photodetector, such as an avalanche photodiode, an infrared photodetector, a quantum well infrared photodetector, a microbolometer, or other detector capable of converting electromagnetic radiation (e.g., of a certain wavelength) to a pixel value. The array of detectors may be arranged in rows and columns.

The detector output image may be, or may be considered, a data structure that includes pixels and is a representation of the image data associated with the scene 675, with each pixel having a pixel value that represents electromagnetic radiation emitted or reflected from a portion of the scene 675 and received by a detector that generates the pixel value. Based on context, a pixel may refer to a detector of the image detector circuit 665 that generates an associated pixel value or a pixel (e.g., pixel location, pixel coordinate) of the detector output image formed from the generated pixel values. In one example, the detector output image may be an infrared image (e.g., thermal infrared image). For a thermal infrared image (e.g., also referred to as a thermal image), each pixel value of the thermal infrared image may represent a temperature of a corresponding portion of the scene 675. In another example, the detector output image may be a visible-light image.

In an aspect, the pixel values generated by the image detector circuit 665 may be represented in terms of digital count values generated based on the electrical signals obtained from converting the detected radiation. For example, in a case that the image detector circuit 665 includes or is otherwise coupled to an ADC circuit, the ADC circuit may generate digital count values based on the electrical signals. In some embodiments, the ADC circuit may be a multi-ranging ADC circuit, such as a two-slope ADC circuit. For an ADC circuit that can represent an electrical signal using 14 bits, the digital count value may range from 0 to 16,383. In such cases, the pixel value of the detector may be the digital count value output from the ADC circuit. In other cases (e.g., in cases without an ADC circuit), the pixel value may be analog in nature with a value that is, or is indicative of, the value of the electrical signal. As an example, for infrared imaging, a larger amount of IR radiation being incident on and detected by the image detector circuit 665 (e.g., an IR image detector circuit) is associated with higher digital count values and higher temperatures.

The readout circuit 670 may be utilized as an interface between the image detector circuit 665 that detects the image data and the logic device 610 that processes the detected image data as read out by the readout circuit 670, with communication of data from the readout circuit 670 to the logic device 610 facilitated by the image interface 625. An image capturing frame rate may refer to the rate (e.g., detector output images per second) at which images are detected/output in a sequence by the image detector circuit 665 and provided to the logic device 610 by the readout circuit 670. The readout circuit 670 may read out the pixel values generated by the image detector circuit 665 in accordance with an integration time (e.g., also referred to as an integration period).

In various embodiments, a combination of the image detector circuit 665 and the readout circuit 670 may be, may include, or may together provide an FPA. In some aspects, the image detector circuit 665 may be a thermal image detector circuit that includes an array of microbolometers, and the combination of the image detector circuit 665 and the readout circuit 670 may be referred to as a microbolometer FPA. In some cases, the array of microbolometers may be arranged in rows and columns. The microbolometers may detect IR radiation and generate pixel values based on the detected IR radiation. For example, in some cases, the microbolometers may be thermal IR detectors that detect IR radiation in the form of heat energy and generate pixel values based on the amount of heat energy detected. The microbolometers may absorb incident IR radiation and produce a corresponding change in temperature in the microbolometers. The change in temperature is associated with a corresponding change in resistance of the microbolometers. With each microbolometer functioning as a pixel, a two-dimensional image or picture representation of the incident IR radiation can be generated by translating the changes in resistance of each microbolometer into a time-multiplexed electrical signal. The translation may be performed by the ROIC. The microbolometer FPA may include IR detecting materials such as amorphous silicon (a-Si), vanadium oxide (VOₓ), a combination thereof, and/or other detecting material(s). In an aspect, for a microbolometer FPA, the integration time may be, or may be indicative of, a time interval during which the microbolometers are biased. In this case, a longer integration time may be associated with higher gain of the IR signal, but not more IR radiation being collected. The IR radiation may be collected in the form of heat energy by the microbolometers.

In some cases, the image capture component 620 may include one or more optical components and/or one or more filters. The optical component(s) may include one or more windows, lenses, mirrors, beamsplitters, beam couplers, and/or other components to direct and/or focus radiation to the image detector circuit 665. The optical component(s) may include components each formed of material and appropriately arranged according to desired transmission characteristics, such as desired transmission wavelengths and/or ray transfer matrix characteristics. The filter(s) may be adapted to pass radiation of some wavelengths but substantially block radiation of other wavelengths. For example, the image capture component 620 may be an IR imaging device that includes one or more filters adapted to pass IR radiation of some wavelengths while substantially blocking IR radiation of other wavelengths (e.g., MWIR filters, thermal IR filters, and narrow-band filters). In this example, such filters may be utilized to tailor the image capture component 620 for increased sensitivity to a desired band of IR wavelengths. In an aspect, an IR imaging device may be referred to as a thermal imaging device when the IR imaging device is tailored for capturing thermal IR images. Other imaging devices, including IR imaging devices tailored for capturing infrared IR images outside the thermal range, may be referred to as non-thermal imaging devices.

In one specific, not-limiting example, the image capture component 620 may include an IR imaging sensor having an FPA of detectors responsive to IR radiation including near infrared (NIR), SWIR, MWIR, LWIR, and/or very-long wave IR (VLWIR) radiation. In some other embodiments, alternatively or in addition, the image capture component 620 may include a complementary metal oxide semiconductor (CMOS) sensor or a charge-coupled device (CCD) sensor that can be found in any consumer camera (e.g., visible light camera).

In some embodiments, the imaging system 600 includes a shutter 685. The shutter 685 may be operated to selectively inserted into an optical path between the scene 675 and the image capture component 620 to expose or block the aperture 680. In some cases, the shutter 685 may be moved (e.g., slid, rotated, etc.) manually (e.g., by a user of the imaging system 600) and/or via an actuator (e.g., controllable by the logic device 610 in response to user input or autonomously, such as an autonomous decision by the logic device 610 to perform a calibration of the imaging device 605). When the shutter 685 is outside of the optical path to expose the aperture 680, the electromagnetic radiation from the scene 675 may be received by the image detector circuit 665 (e.g., via one or more optical components and/or one or more filters). As such, the image detector circuit 665 captures images of the scene 675. The shutter 685 may be referred to as being in an open position or simply as being open. When the shutter 685 is inserted into the optical path to block the aperture 680, the electromagnetic radiation from the scene 675 is blocked from the image detector circuit 665. As such, the image detector circuit 665 captures images of the shutter 685. The shutter 685 may be referred to as being in a closed position or simply as being closed. In some cases, the shutter 685 may block the aperture 680 during a calibration process, in which the shutter 1485 may be used as a uniform blackbody (e.g., a substantially uniform blackbody). For example, the shutter 685 may be used as a single temperature source or substantially single temperature source. In some cases, the shutter 685 may be temperature controlled to provide a temperature controlled uniform blackbody (e.g., to present a uniform field of radiation to the image detector circuit 665). For example, in some cases, a surface of the shutter 685 imaged by the image detector circuit 665 may be implemented by a uniform blackbody coating. In some cases, such as for an imaging device without a shutter or with a broken shutter or as an alternative to the shutter 685, a case or holster of the imaging device 605, a lens cap, a cover, a wall of a room, or other suitable object/surface may be used to provide a uniform blackbody (e.g., substantially uniform blackbody) and/or a single temperature source (e.g., substantially single temperature source).

Other imaging sensors that may be embodied in the image capture component 620 include a photonic mixer device (PMD) imaging sensor or other time of flight (ToF) imaging sensor, LIDAR imaging device, RADAR imaging device, millimeter imaging device, positron emission tomography (PET) scanner, single photon emission computed tomography (SPECT) scanner, ultrasonic imaging device, or other imaging devices operating in particular modalities and/or spectra. It is noted that for some of these imaging sensors that are configured to capture images in particular modalities and/or spectra (e.g., infrared spectrum, etc.), they are more prone to produce images with low frequency shading, for example, when compared with a typical CMOS-based or CCD-based imaging sensors or other imaging sensors, imaging scanners, or imaging devices of different modalities.

The images, or the digital image data corresponding to the images, provided by the image capture component 620 may be associated with respective image dimensions (also referred to as pixel dimensions). An image dimension, or pixel dimension, generally refers to the number of pixels in an image, which may be expressed, for example, in width multiplied by height for two-dimensional images or otherwise appropriate for relevant dimension or shape of the image. Thus, images having a native resolution may be resized to a smaller size (e.g., having smaller pixel dimensions) in order to, for example, reduce the cost of processing and analyzing the images. Filters (e.g., a non-uniformity estimate) may be generated based on an analysis of the resized images. The filters may then be resized to the native resolution and dimensions of the images, before being applied to the images.

The image interface 625 may include, in some embodiments, appropriate input ports, connectors, switches, and/or circuitry configured to interface with external devices (e.g., a remote device 655 and/or other devices) to receive images (e.g., digital image data) generated by or otherwise stored at the external devices. In an aspect, the image interface 625 may include a serial interface and telemetry line for providing metadata associated with image data. The received images or image data may be provided to the logic device 610. In this regard, the received images or image data may be converted into signals or data suitable for processing by the logic device 610. For example, in one embodiment, the image interface 625 may be configured to receive analog video data and convert it into suitable digital data to be provided to the logic device 610.

The image interface 625 may include various standard video ports, which may be connected to a video player, a video camera, or other devices capable of generating standard video signals, and may convert the received video signals into digital video/image data suitable for processing by the logic device 610. In some embodiments, the image interface 625 may also be configured to interface with and receive images (e.g., image data) from the image capture component 620. In other embodiments, the image capture component 620 may interface directly with the logic device 610.

The control component 630 includes, in one embodiment, a user input and/or an interface device, such as a rotatable knob (e.g., potentiometer), push buttons, slide bar, keyboard, and/or other devices, that is adapted to generate a user input control signal. The logic device 610 may be configured to sense control input signals from a user via the control component 630 and respond to any sensed control input signals received therefrom. The logic device 610 may be configured to interpret such a control input signal as a value, as generally understood by one skilled in the art. In one embodiment, the control component 630 may include a control unit (e.g., a wired or wireless handheld control unit) having push buttons adapted to interface with a user and receive user input control values. In one implementation, the push buttons and/or other input mechanisms of the control unit may be used to control various functions of the imaging device 605, such as calibration initiation and/or related control, shutter control, autofocus, menu enable and selection, field of view, brightness, contrast, noise filtering, image enhancement, and/or various other features.

The display component 635 includes, in one embodiment, an image display device (e.g., a liquid crystal display (LCD)) or various other types of generally known video displays or monitors. The logic device 610 may be configured to display image data and information on the display component 635. The logic device 610 may be configured to retrieve image data and information from the memory component 615 and display any retrieved image data and information on the display component 635. The display component 635 may include display circuitry, which may be utilized by the logic device 610 to display image data and information. The display component 635 may be adapted to receive image data and information directly from the image capture component 620, logic device 610, and/or image interface 625, or the image data and information may be transferred from the memory component 615 via the logic device 610. In some aspects, the control component 630 may be implemented as part of the display component 635. For example, a touchscreen of the imaging device 605 may provide both the control component 630 (e.g., for receiving user input via taps and/or other gestures) and the display component 635 of the imaging device 605.

The sensing component 640 includes, in one embodiment, one or more sensors of various types, depending on the application or implementation requirements, as would be understood by one skilled in the art. Sensors of the sensing component 640 provide data and/or information to at least the logic device 610. In one aspect, the logic device 610 may be configured to communicate with the sensing component 640. In various implementations, the sensing component 640 may provide information regarding environmental conditions, such as outside temperature, lighting conditions (e.g., day, night, dusk, and/or dawn), humidity level, specific weather conditions (e.g., sun, rain, and/or snow), distance (e.g., laser rangefinder or time-of-flight camera), and/or whether a tunnel or other type of enclosure has been entered or exited. The sensing component 640 may represent conventional sensors as generally known by one skilled in the art for monitoring various conditions (e.g., environmental conditions) that may have an effect (e.g., on the image appearance) on the image data provided by the image capture component 620.

In some implementations, the sensing component 640 (e.g., one or more sensors) may include devices that relay information to the logic device 610 via wired and/or wireless communication. For example, the sensing component 640 may be adapted to receive information from a satellite, through a local broadcast (e.g., radio frequency (RF)) transmission, through a mobile or cellular network and/or through information beacons in an infrastructure (e.g., a transportation or highway information beacon infrastructure), or various other wired and/or wireless techniques. In some embodiments, the logic device 610 can use the information (e.g., sensing data) retrieved from the sensing component 640 to modify a configuration of the image capture component 620 (e.g., adjusting a light sensitivity level, adjusting a direction or angle of the image capture component 620, adjusting an aperture, etc.). The sensing component 640 may include a temperature sensing component to provide temperature data (e.g., one or more measured temperature values) various components of the imaging device 605, such as the image detection circuit 665 and/or the shutter 685. By way of non-limiting examples, a temperature sensor may include a thermistor, thermocouple, thermopile, pyrometer, and/or other appropriate sensor for providing temperature data.

In some embodiments, various components of the imaging system 600 may be distributed and in communication with one another over a network 660. In this regard, the imaging device 605 may include a network interface 645 configured to facilitate wired and/or wireless communication among various components of the imaging system 600 over the network 660. In such embodiments, components may also be replicated if desired for particular applications of the imaging system 600. That is, components configured for same or similar operations may be distributed over a network. Further, all or part of any one of the various components may be implemented using appropriate components of the remote device 655 (e.g., a conventional digital video recorder (DVR), a computer configured for image processing, and/or other device) in communication with various components of the imaging system 600 via the network interface 645 over the network 660, if desired. Thus, for example, all or part of the logic device 610, all or part of the memory component 615, and/or all of part of the display component 635 may be implemented or replicated at the remote device 655. In some embodiments, the imaging system 600 may not include imaging sensors (e.g., image capture component 620), but instead receive images or image data from imaging sensors located separately and remotely from the logic device 610 and/or other components of the imaging system 600. It will be appreciated that many other combinations of distributed implementations of the imaging system 600 are possible, without departing from the scope and spirit of the disclosure.

Furthermore, in various embodiments, various components of the imaging system 600 may be combined and/or implemented or not, as desired or depending on the application or requirements. In one example, the logic device 610 may be combined with the memory component 615, image capture component 620, image interface 625, display component 635, sensing component 640, and/or network interface 645. In another example, the logic device 610 may be combined with the image capture component 620, such that certain functions of the logic device 610 are performed by circuitry (e.g., a processor, a microprocessor, a logic device, a microcontroller, etc.) within the image capture component 620.

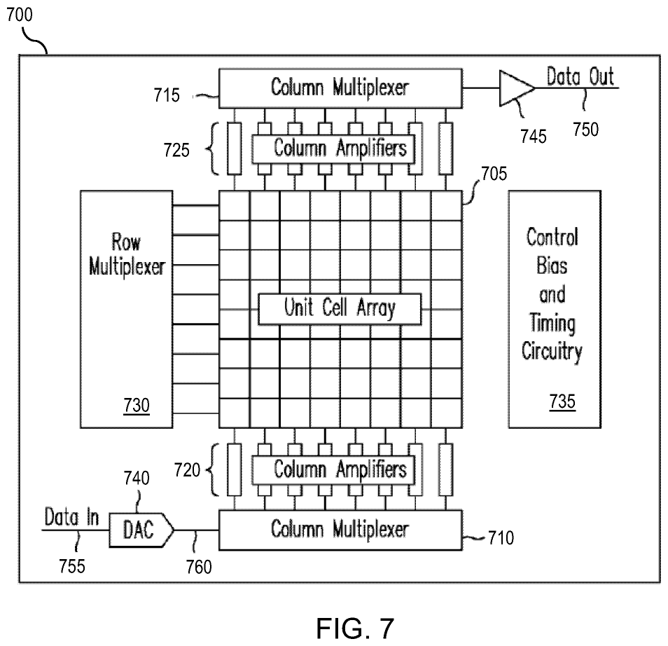

FIG. 7 illustrates a block diagram of an example image sensor assembly 700 in accordance with one or more embodiments of the present disclosure. Not all of the depicted components may be required, however, and one or more embodiments may include additional components not shown in the figure. Variations in the arrangement and type of the components may be made without departing from the spirit or scope of the claims as set forth herein. Additional components, different components, and/or fewer components may be provided. In an embodiment, the image sensor assembly 700 may be an FPA, for example, implemented as the image capture component 720 of FIG. 6.

The image sensor assembly 700 includes a unit cell array 705, column multiplexers 710 and 715, column amplifiers 720 and 725, a row multiplexer 730, control bias and timing circuitry 735, a digital-to-analog converter (DAC) 740, and a data output buffer 745. In some aspects, operations of and/or pertaining to the unit cell array 705 and other components may be performed according to a system clock and/or synchronization signals (e.g., line synchronization (LSYNC) signals). The unit cell array 705 includes an array of unit cells. In an aspect, each unit cell may include a detector (e.g., a pixel) and interface circuitry. The interface circuitry of each unit cell may provide an output signal, such as an output voltage or an output current, in response to a detection signal (e.g., detection current, detection voltage) provided by the detector of the unit cell. The output signal may be indicative of the magnitude of electromagnetic radiation received by the detector and may be referred to as image pixel data or simply image data. The column multiplexer 715, column amplifiers 720, row multiplexer 730, and data output buffer 745 may be used to provide the output signals from the unit cell array 705 as a data output signal on a data output line 750. The output signals on the data output line 750 may be provided to components downstream of the image sensor assembly 700, such as processing circuitry (e.g., the logic device 610 of FIG. 6), memory (e.g., the memory component 615 of FIG. 6), display device (e.g., the display component 635 of FIG. 6), and/or other component to facilitate processing, storage, and/or display of the output signals. The data output signal may be an image formed of the pixel values for the image sensor assembly 700. In this regard, the column multiplexer 715, the column amplifiers 720, the row multiplexer 730, and the data output buffer 745 may collectively provide an ROIC (or portion thereof) of the image sensor assembly 700. In an aspect, the interface circuitry may be considered part of the ROIC, or may be considered an interface between the detectors and the ROIC. In some embodiments, components of the image sensor assembly 700 may be implemented such that the unit cell array 705 and the ROIC may be part of a single die.

The column amplifiers 725 may generally represent any column processing circuitry as appropriate for a given application (analog and/or digital), and is not limited to amplifier circuitry for analog signals. In this regard, the column amplifiers 725 may more generally be referred to as column processors in such an aspect. Signals received by the column amplifiers 725, such as analog signals on an analog bus and/or digital signals on a digital bus, may be processed according to the analog or digital nature of the signal. As an example, the column amplifiers 725 may include circuitry for processing digital signals. As another example, the column amplifiers 725 may be a path (e.g., no processing) through which digital signals from the unit cell array 705 traverses to get to the column multiplexer 715. As another example, the column amplifiers 725 may include an ADC for converting analog signals to digital signals (e.g., to obtain digital count values). These digital signals may be provided to the column multiplexer 715.

Each unit cell may receive a bias signal (e.g., bias voltage, bias current) to bias the detector of the unit cell to compensate for different response characteristics of the unit cell attributable to, for example, variations in temperature, manufacturing variances, and/or other factors. For example, the control bias and timing circuitry 735 may generate the bias signals and provide them to the unit cells. By providing appropriate bias signals to each unit cell, the unit cell array 1505 may be effectively calibrated to provide accurate image data in response to light (e.g., visible-light, IR light) incident on the detectors of the unit cells. In an aspect, the control bias and timing circuitry 1535 may be, may include, or may be a part of, a logic circuit.

The control bias and timing circuitry 735 may generate control signals for addressing the unit cell array 705 to allow access to and readout of image data from an addressed portion of the unit cell array 705. The unit cell array 705 may be addressed to access and readout image data from the unit cell array 705 row by row, although in other implementations the unit cell array 1505 may be addressed column by column or via other manners.

The control bias and timing circuitry 735 may generate bias values and timing control voltages. In some cases, the DAC 740 may convert the bias values received as, or as part of, data input signal on a data input signal line 755 into bias signals (e.g., analog signals on analog signal line(s) 760) that may be provided to individual unit cells through the operation of the column multiplexer 710, column amplifiers 720, and row multiplexer 730. For example, the DAC 740 may drive digital control signals (e.g., provided as bits) to appropriate analog signal levels for the unit cells. In some technologies, a digital control signal of 0 or 1 may be driven to an appropriate logic low voltage level or an appropriate logic high voltage level, respectively. In another aspect, the control bias and timing circuitry 735 may generate the bias signals (e.g., analog signals) and provide the bias signals to the unit cells without utilizing the DAC 740. In this regard, some implementations do not include the DAC 740, data input signal line 755, and/or analog signal line(s) 760. In an embodiment, the control bias and timing circuitry 735 may be, may include, may be a part of, or may otherwise be coupled to the logic device 610 and/or image capture component 620 of FIG. 6.

In an embodiment, the image sensor assembly 700 may be implemented as part of an imaging device (e.g., the imaging device 605). In addition to the various components of the image sensor assembly 700, the imaging device may also include one or more processors, memories, logic, displays, interfaces, optics (e.g., lenses, mirrors, beamsplitters), and/or other components as may be appropriate in various implementations. In an aspect, the data output signal on the data output line 750 may be provided to the processors (not shown) for further processing. For example, the data output signal may be an image formed of the pixel values from the unit cells of the image sensor assembly 700. The processors may perform operations such as non-uniformity correction (e.g., flat-field correction or other calibration technique), spatial and/or temporal filtering, and/or other operations. The images (e.g., processed images) may be stored in memory (e.g., external to or local to the imaging system) and/or displayed on a display device (e.g., external to and/or integrated with the imaging system). The various components of FIG. 7 may be implemented on a single chip or multiple chips. Furthermore, while the various components are illustrated as a set of individual blocks, various of the blocks may be merged together or various blocks shown in FIG. 7 may be separated into separate blocks.

It is noted that in FIG. 7 the unit cell array 705 is depicted as an 8×8 (e.g., 8 rows and 8 columns of unit cells. However, the unit cell array 705 may be of other array sizes. By way of non-limiting examples, the unit cell array 705 may include 160×120 (e.g., 160 rows and 120 columns of unit cells), 512×512, 1024×1024, 2048×2048, 4096×4096, 8192×8192, and/or other array sizes. In some cases, the array size may have a row size (e.g., number of detectors in a row) different from a column size (e.g., number of detectors in a column). Examples of frame rates may include 30 Hz, 60 Hz, and 120 Hz. In an aspect, each unit cell of the unit cell array 705 may represent a pixel.

It is noted that dimensional aspects provided above are examples and that other values for the dimensions can be utilized in accordance with one or more implementations. Furthermore, the dimensional aspects provided above are generally nominal values. As would be appreciated by a person skilled in the art, each dimensional aspect has a tolerance associated with the dimensional aspect. Similarly, aspects related to distances between features also have associated tolerances.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice versa.

Software in accordance with the present disclosure, such as non-transitory instructions, program code, and/or data, can be stored on one or more non-transitory machine readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

The foregoing description is not intended to limit the present disclosure to the precise forms or particular fields of use disclosed. Embodiments described above illustrate but do not limit the invention. It is contemplated that various alternate embodiments and/or modifications to the present invention, whether explicitly described or implied herein, are possible in light of the disclosure. Accordingly, the scope of the invention is defined only by the following claims.

What is claimed is:

1. An imaging device comprising:
a lens system comprising:
a first lens element configured to transmit electromagnetic radiation associated with a scene;
a second lens element configured to receive the electromagnetic radiation from the first lens element and transmit the electromagnetic radiation; and
a third lens element configured to receive the electromagnetic radiation from the second lens element and transmit the electromagnetic radiation, wherein the first lens element and the third lens element comprise As₄₀Se₆₀, and wherein the second lens element comprises Ge₂₂As₂₀Se₅₈ or Ge₂₈Sb₁₂Se₆₀;
a detector array comprising a plurality of detectors, wherein each of the plurality of detectors is configured to receive a portion of the electromagnetic radiation from the lens system and generate an infrared image based on the electromagnetic radiation.

2. The imaging device of claim 1, wherein the lens system is configured to distribute an optical power associated with the electromagnetic radiation among at least two of the first lens element, the second lens element, and the third lens element such that a change in a focal length of at least one lens element of the first lens element, the second lens element, and the third lens element in response to a change in a temperature of the lens system is at least partially cancelled by a change in a focal length of at least one remaining lens element of the first lens element, the second lens element, and the third lens element.

3. The imaging device of claim 1, wherein the lens system is associated with a field of view less than 25°.

4. The imaging device of claim 1, wherein the lens system is associated with a focal length greater than 20 mm.

5. The imaging device of claim 1, further comprising a shutter configured to be selectively inserted between the scene and the first lens element.

6. The imaging device of claim 1, further comprising a lens barrel configured to receive the first lens element, the second lens element, and the third lens element.

7. The imaging device of claim 6, further comprising a housing, wherein the lens barrel is coupled to the housing.

8. The imaging device of claim 1, wherein the electromagnetic radiation comprises long-wave infrared light, and/or wherein the detector array comprises an array of microbolometers.

9. The imaging device of claim 1, wherein the lens system has a lens prescription according to Table 1.

10. The imaging device of claim 1, further comprising:
a logic device configured to process the infrared image to obtain a processed image; and
a display device configured to display the infrared image and/or the processed image.

11. A method of manufacturing the imaging device of claim 1, the method comprising:
providing the detector array;
disposing the detector array within a housing; and
disposing the first lens element, the second lens element, and the third lens element within a lens barrel.

12. The method of claim 11, further comprising forming each of the first lens element, the second lens element, and the third lens element using one or more wafer-level optics (WLO) manufacturing processes, one or more grinding processes, one or more diamond turning processes, one or more polishing processes, and/or one or more molding processes.

13. A lens system comprising:
a first lens element configured to transmit electromagnetic radiation associated with a scene;
a second lens element configured to receive the electromagnetic radiation from the first lens element and transmit the electromagnetic radiation; and
a third lens element configured to receive the electromagnetic radiation from the second lens element and transmit the electromagnetic radiation, wherein the first lens element and the third lens element comprise As₄₀Se₆₀, and wherein the second lens element comprises Ge₂₂As₂₀Se₅₈ or Ge₂₈Sb₁₂Se₆₀.

14. The lens system of claim 13, wherein the lens system is configured to distribute an optical power associated with the electromagnetic radiation among at least two of the first lens element, the second lens element, and the third lens element such that a change in a focal length of at least one lens element of the first lens element, the second lens element, and the third lens element in response to a change in a temperature of the lens system is at least partially cancelled by a change in a focal length of at least one remaining lens element of the first lens element, the second lens element, and the third lens element.

15. The lens system of claim 13, wherein the lens system is associated with a field of view less than 25°, and/or wherein the lens system is associated with a focal length greater than 20 mm.

16. A method comprising:
directing, by a lens system comprising a first lens element, a second lens element, and a third lens element, electromagnetic radiation associated with a scene to a detector array, wherein the first lens element and the third lens element comprise As₄₀Se₆₀, and wherein the second lens element comprises Ge₂₂As₂₀Se₅₈ or Ge₂₈Sb₁₂Se₆₀; and
receiving, by the detector array, the electromagnetic radiation; and
generating, by the detector array, an infrared image based on the electromagnetic radiation.

17. The method of claim 16, further comprising displaying, by a display device, the infrared image, wherein the electromagnetic radiation comprises long-wave infrared light.

18. The method of claim 16, wherein the directing comprises distributing an optical power associated with the electromagnetic radiation among at least two of the first lens element, the second lens element, and the third lens element such that a change in a focal length of at least one lens element of the first lens element, the second lens element, and the third lens element in response to a change in a temperature of the lens system is at least partially cancelled by a change in a focal length of at least one remaining lens element of the first lens element, the second lens element, and the third lens element.

19. The method of claim 16, further comprising, in response to a change in a temperature of the lens system, substantially maintaining a focal length associated with the lens system by adjusting a focal length associated with at least two lens elements of the first lens element, the second lens element, and the third lens element such that a change in the focal length of one or more lens elements of the lens system is substantially cancelled by a change in the focal length of one or more remaining lens elements of the lens system.

20. The method of claim 19, wherein, for each lens element of the first lens element, the second lens element, and the third lens element, the respective focal length is adjusted in response to a corresponding change in an index of refraction of the lens element and/or a corresponding change in a size of the lens element.
